(19) United States
(12) Patent Application Publication
(10) Pub. No.: US 2012/0328131 A1
(43) Pub. Date: Dec. 27, 2012

(54) System for High Efficiency Vibratory Acoustic Stimulation

(75) Inventor: Clemens M. Zierhofer, Kundl (AT)

(73) Assignee: MED-EL ELEKTROMEDIZINISCHE GERAETE GMBH, Innsbruck (AT)

(21) Appl. No.: 13/166,261

(22) Filed: Jun. 22, 2011

(51) Int. Cl. H04R 1/00

(52) U.S. Cl. 381/151

(57) ABSTRACT

A system and method of driving a floating mass transducer with an analog input signal u_{IN}(t), u_{IN}(t) being between ground and V_{CC}, is provided. The method includes converting u_{IN}(t) to a binary rectangular signal u_{R}(t) with two levels V_{CC} and GND. A switching network is driven with u_{R}(t) so as to switch nodes N₁ and N₂ between V_{CC} and ground. The floating mass transducer is coupled between nodes N₁ and N₂ to a capacitor C in parallel, and further to a coil L in series.

### TECHNICAL FIELD

The present invention relates to a system and method for high efficiency vibratory acoustic stimulation, and more particularly to a system and method for efficiently driving a floating mass transducer.

### BACKGROUND ART

The standard treatment of hearing impaired persons is to use conventional hearing aids, which are essentially based on filtering and amplifying the acoustic signal. Another possibility is to employ so called “middle ear implants” which are based on vibratory systems. A vibratory system is an actuator driven by a signal derived from the acoustic signal and causes mechanical movements of structures in the middle ear or inner ear, which cause sound-like sensations. One example of such a vibratory system is the so called “Floating Mass Transducer (FMT)” described, for example, in U.S. Pat. No. 5,456,654 (Ball), which is hereby incorporated herein by reference in its entirety.

A FMT illustratively may include a magnet positioned inside a housing. The housing is proportioned to be disposed in the ear and in contact with middle ear or internal ear structures such as the ossicles, or the oval window. A coil is also disposed inside the housing. The coil and magnet are each connected to the housing, and the coil is typically more rigidly connected to the housing than the magnet. When alternating current is delivered to the coil, the magnetic field generated by the coil interacts with the magnetic field of the magnet causing both the magnet and the coil to vibrate. As the current alternates, the magnet, and the coil and housing alternately move towards and away from each other. The vibrations produce actual side-to-side displacement of the housing and thereby vibrate the structure in the ear to which the housing is connected.

The electrical equivalent circuit of an FMT as described above is approximated by an ohmic resistor of about R_{L}=50Ω. From the engineering point of view, R_{L} is a low impedance load, and one of the problems is to drive such a load at a high overall power efficiency.

One textbook approach of driving R_{L} is to use a push-pull emitter follower as shown in FIG. 1 (prior art). The system is supplied symmetrically with +VCC and −VCC, and input and output voltages u_{IN}(t) and u_{R}(t) are referred to ground potential GND. The circuit consists of npn-transistor T₁, pnp-transistor T₂, and R_{L}. T₁ conducts on positive swings of the input signal u_{IN}(t), T₂ on negative swings. Voltage u_{L}(t) and input voltage u_{IN}(t) are approximately related via

u_{L}(t)≈u_{IN}(t)+U_{F} for u_{IN}(t)<−U_{F}

u_{L}(t)≈0 for −U_{F}<u_{IN}(t)<U_{F}

u_{L}(t)≈u_{IN}(t)−U_{F} for u_{IN}(t)>U_{F} (1)

where U_{F} denotes the base-emitter voltage of about U_{F}≈0.7 V.

For the estimation of the efficiency of such a push-pull amplifier, the base-emitter voltage is neglected. The output voltage then is equal to the input voltage, i.e., u_{L}(t)≅=u_{IN}(t).

For a sinusoidal input voltage

u_{IN}(t)=a₀ sin Ωt (2)

with frequency

$$ω = \frac{2 π}{T} ( period T ) ,$$

the mean power consumption P_{L} in R_{L} is given by

$${P}_{L} = \frac{1}{T} {\int }_{T} \frac{{{u}_{IN} ( t )}^{2}}{{R}_{L}} d t = \frac{{a}_{0}^{2}}{2 {R}_{L}} \qquad ( 3 )$$

The overall mean power P₀₀ used in R_{L} and the two transistors T₁ and T₂ is given by

$${P}_{00} = \frac{2}{T} {\int }_{T / 2} \frac{{V}_{CC} {u}_{IN} ( t )}{{R}_{L}} d t = \frac{2}{π} \frac{{V}_{CC} {a}_{0}}{{R}_{L}} \qquad ( 4 )$$

The overall efficiency η defined as the ratio of the power delivered to the load in the signal band and the overall power is obtained as

$$η = \frac{π}{4} \frac{{a}_{0}}{{V}_{CC}} \qquad ( 5 )$$

Clearly, the maximum efficiency of about η≈0.78 is reached for the maximum input voltage swing with amplitude aₒ=V_{CC}. Note that for decreasing amplitudes a₀, the efficiency is decreasing linearly.

### SUMMARY OF THE EMBODIMENTS

In accordance with an embodiment of the invention, a method of driving a floating mass transducer with an analog input signal u_{IN}(t) is provided. The method includes converting u_{IN}(t) to a binary rectangular signal u_{R}(t) with two levels V_{CC} and GND. A switching network is driven with u_{R}(t) so as to switch nodes N₁ and N₂ between V_{CC} and ground. The floating mass transducer is coupled between nodes N₁ and N₂ to a capacitor C in parallel, and further to a coil L in series.

In accordance with related embodiments of the invention, converting u_{IN}(t) may include ΔΣ-modulation or pulse width modulation (PWM). Driving the switching network with u_{R}(t) so as to switch nodes N₁ and N₂ between V_{CC} and ground may include connecting N₁ to ground when N₂ is connected to V_{CC}, and connecting N₁ to V_{CC} when N₂ is connected to ground. For example, N₁ may be coupled to V_{CC} via a PMOS-transistor T₁, N₁ may be coupled to ground via a NMOS-transistor T₂, N₂ may be coupled to Vcc via a PMOS-transistor T₃, N₂ may be coupled to ground via a NMOS-transistor T₄, and wherein u_{R}(t) drives T₁ and T₂, and u̅_̅{̅R̅}̅(̅t̅)̅ drives T₃ and T₄. The power efficiency of driving the floating mass transducer may be independent of the amplitude of the analog input signal u_{IN}(t).

In accordance with another embodiment of the invention, a system for high efficiency vibratory acoustic stimulation is provided. The system includes a modulator having an input for receiving an analog signal u_{IN}(t), and providing at an output, as a function of u_{IN}(t), a binary rectangular signal output u_{R}(t) with two levels V_{CC} and GND. A switching network is coupled to u_{R}(t) so as to switch nodes N₁ and N₂ between V_{CC} and ground. A floating mass transducer is coupled between nodes N₁ and N₂ to a capacitor C in parallel, and further to a coil L in series.

In accordance with related embodiments of the invention, the modulator may be a ΔΣ-modulator or a pulse width modulator. The switching network may connect N₁ to ground when N₂ is connected to V_{CC}, and connect N₁ to V_{CC} when N₂ is connected to ground. For example, N₁ may be coupled to V_{CC} via a PMOS-transistor T₁, N₁ may be coupled to ground via a NMOS-transistor T₂, N₂ may be coupled to Vcc via a PMOS-transistor T₃, N₂ may be coupled to ground via a NMOS-transistor T₄, and wherein u_{R}(t) drives T₁ and T₂, and u̅_̅{̅R̅}̅(̅t̅)̅ drives T₃ and T₄. The power efficiency of driving the floating mass transducer may be independent of the amplitude of the analog input signal u_{IN}(t).

### BRIEF DESCRIPTION OF THE DRAWINGS

The foregoing features of embodiments will be more readily understood by reference to the following detailed description, taken with reference to the accompanying drawings, in which:

FIG. 1 shows a system for driving an FMT that uses a push-pull emitter follower (prior art);

FIG. 2 shows a system for driving an FMT, in accordance with an embodiment of the invention; and

FIG. 3 shows a R_{L}, L, and C network between nodes N₁ and N₂ driven by an ideal voltage source u_{E}(t), in accordance with an embodiment of the invention.

### DETAILED DESCRIPTION OF SPECIFIC EMBODIMENTS

A system and method for high efficiency vibratory acoustic stimulation is presented. The system, which illustratively may be used to drive a floating mass transducer, converts an analog input signal into a rectangular signal. The rectangular signal is used to drive a switching network that is further coupled to an RCL circuit including the floating mass transducer. The floating mass transducer may be employed, for example, in a middle ear implant. Details are described below.

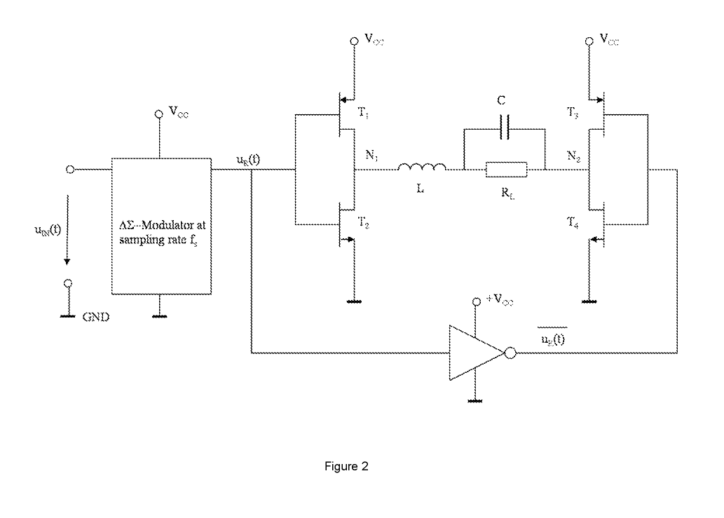

FIG. 2 shows a class-D amplifier driving an FMT in an H-bridge configuration, in accordance with an embodiment of the invention. Class-D drivers in combination with H-bridges can be found in audio applications, e.g., Junle Pan, Libin Yao, Yong Lian, “A Sigma-Delta class-D audio power amplifier in 0.35 μm CMOS technology,” SoC Design Conference, 2008, ISOCC '08, Digital Object Identifier: 10.1109/SOCDC.2008.4815561, pp. I-5-I-8, 2008, which is hereby incorporated herein by reference in its entirety.

The system includes, without limitation, four transistors T₁, T₂, T₃, and T₄, which are operated as switches. Transistors T₁, T₂, T₃, and T₄, may be, for example, MOS transistors. Load resistor R_{L} representing the FMT is connected to a coil L and a capacitor C. The circuit is operated between supply voltage V_{CC} and ground potential GND.

The input u_{IN}(t) is converted to a rectangular signal u_{R}(t) with two levels +V_{CC} and GND. This may be achieved, for example, using a ΔΣ-modulator at a particular sampling rate fₛ (see, for example, J. C. Candy and G. C. Temes, Oversampled Delta-Sigma Data Converters, Piscataway, N.J.: IEEE-press, 1992, which is hereby incorporated herein by reference in its entirety. The sampling rate typically is much higher than twice the bandwidth of u_{IN}(t). For example, if u_{IN}(t) is an audio signal with spectral components smaller than 20 kHz, the sampling rate typically could be fₛ=1 MHz. Signal u_{R}(t) is a superposition of a dc-component V_{CC}/2, input signal u_{IN}(t), and a noise signal γ(t), i.e.,

u_{R}(t)=V_{cc}/2+u_{IN}(t)+γ(t) (6)

Applying ΔΣ-modulation, the spectrum of γ(t) is noise shaped, i.e., the amount of noise in the signal band is very small. If a ΔΣ-modulator of 1^{st} order is used, the amplitudes of the noise spectrum is substantially zero at ω=0 (dc) and increasing with about +6 dB/octave within the signal band. A description of such noise spectra is given, for example, in C. M. Zierhofer, “Frequency modulation and first order delta sigma modulation: signal representation with unity weight Dirac impulses,” IEEE Sig. Proc. Lett., vol. 15, pp. 825-828, 2008, which is hereby incorporated herein by reference in its entirety.

Alternative binary representations of u_{IN}(t) may be, without limitation, based on Pulse Width Modulation (PWM). For PWM, u_{IN}(t) is represented by a train of pulses with constant amplitudes and constant rate, where the widths of the pulses are proportional to the instantaneous amplitude of u_{IN}(t).

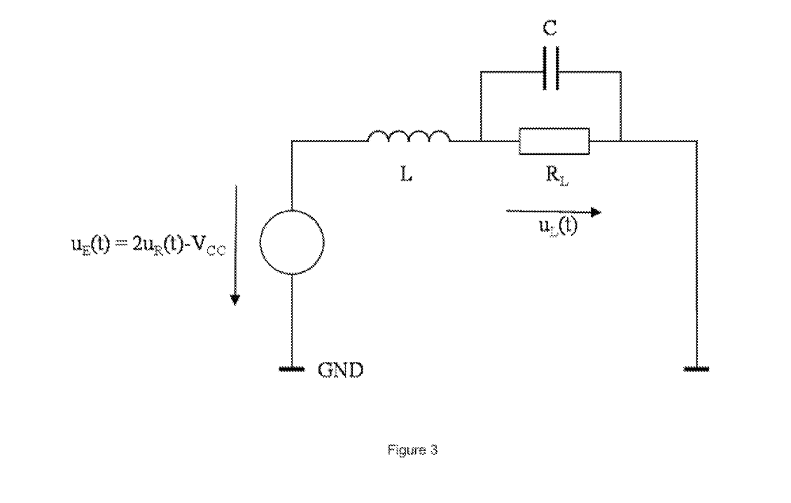

The rectangular signals u_{R}(t) and it's inverse u̅_̅{̅R̅}̅(̅t̅)̅ at the output the inverter are driving the switching transistors T₁, T₂, T₃, and T₄. The purpose of the transistors is to switch nodes N₁ and N₂ between the supply voltage rails. If N₁ is connected to V_{CC} (T₁ conductive), N₂ is connected to GND (T₄ conductive), and vice versa, if N₁ is connected to GND (T₂ conductive), N₂ is connected to V_{CC} (T₃ conductive). Of course, other switching networks, as known, in the art may be used to achieve this function. Assuming ideal switching performance it can be assumed that the network R_{L}, L, and C between nodes N₁ and N₂ is driven by an ideal voltage source u_{E}(t), as shown by FIG. 3, in accordance with an embodiment of the invention. Voltage u_{E}(t) is given by

u_{E}(t)=2u_{IN}(t)+2γ(t) (7)

and is again rectangular with two voltage levels +V_{CC} and −V_{CC}. Because of the push-pull configuration, the dc-component of u_{E}(t) is zero.

For steady state sinusoidal analysis, voltages u_{L}(t) and u_{E}(t) can be represented by the complex pointers U_{L}(jω) and U_{E}(jω). A short calculation yields transfer function

$$\begin{matrix}H ( j ω ) = \frac{{U}_{L} ( j ω )}{{U}_{E} ( j ω )} = \frac{1}{1 - {ω}^{2} LC + jω \frac{L}{R}} \\ and its magnitude & ( 8 ) \\ \vert H ( jω ) \vert = \frac{1}{\sqrt{1 + {ω}^{2} ( \frac{{L}^{2}}{{R}^{2}} - 2 LC ) + {ω}^{4} {L}^{2} {C}^{2}}} & ( 9 )\end{matrix}$$

H(jω) represents a low pass filter. For large frequencies, this expression is approximated by

$${lim}_{ω \to ∞} \vert H ( jω ) \vert = \frac{1}{\sqrt{{ω}^{4} {L}^{2} {C}^{2}}} = \frac{1}{{ω}^{2} LC} \qquad ( 10 )$$

that it is converging towards zero with −12 dB/octave. Since the noise spectrum of the input signal γ(t) is increasing with +6 dB in the signal band, the filtered noise spectrum at R_{L}, is decaying with −6 dB/octave.

The voltage across R_{L} is approximately twice the input signal without dc-component, if some residual noise is neglected, i.e.,

u_{L}(t)≅2u_{IN}(t) (11)

Assuming ideal components L and C, the power efficiency of the circuit shown FIG. 3 theoretically is

η≅1 (12)

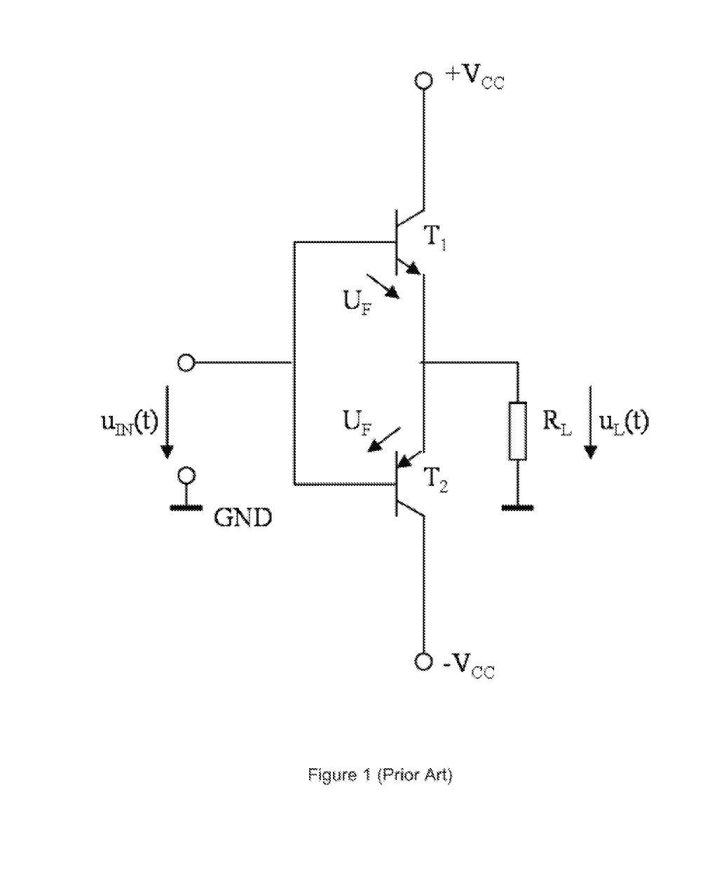

because R_{I}, is the only component that is able to absorb power. Because of (12), the power consumption almost entirely occurs within the signal band. One of the fundamental differences to the push-pull emitter follower FIG. 1 is that the efficiency is independent of the signal amplitude. It remains high even at very small amplitudes of the input which is not the case for the push-pull emitter follower.

The fact that efficiency η is almost independent from the input signal amplitude is mainly due to the passive network L and C around R_{L}. This can easily be understood considering the case that the network is missing, i.e., L=0 and C=0. Then u_{L}(t) is equal to the rectangular voltage u_{E}(t) as defined in (8), i.e.,

u_{L}(t)=u_{E}(t) (13)

That is, a voltage twice the rectangular signal without dc-component applies at R_{L}. In this case, the overall power used in R_{L} is constant, and the fraction of power used within the signal band is proportional to the input signal amplitude. Thus the overall efficiency would be a function similar to (5).

The embodiments of the invention described above are intended to be merely exemplary; numerous variations and modifications will be apparent to those skilled in the art. All such variations and modifications are intended to be within the scope of the present invention.

What is claimed is:

1. A method of driving a floating mass transducer with an analog input signal u_{IN}(t), u_{IN}(t) being between ground and V_{CC}, the method comprising:
converting u_{IN}(t) to a binary rectangular signal u_{R}(t) with two levels V_{CC} and GND;
driving a switching network with u_{R}(t) so as to switch nodes N₁ and N₂ between V_{CC} and ground, wherein the floating mass transducer is coupled between nodes N₁ and N₂ to a capacitor C in parallel, and further to a coil L in series.

2. The method according to claim 1, wherein converting u_{IN}(t) includes ΔΣ-modulation.

3. The method according to claim 1, wherein converting u_{IN}(t) includes pulse width modulation.

4. The method according to claim 1, wherein driving a switching network with u_{R}(t) so as to switch nodes N₁ and N₂ between V_{CC} and ground includes connecting N₁ to ground when N₂ is connected to V_{CC}, and connecting N₁ to V_{CC} when N₂ is connected to ground.

5. The method according to claim 4, wherein N₁ is coupled to V_{CC} via a PMOS-transistor T₁, wherein N₁ is coupled to ground via a NMOS-transistor T₂, wherein N₂ is coupled to Vcc via a PMOS-transistor T₃, wherein N₂ is coupled to ground via a NMOS-transistor T₄, and wherein u_{R}(t) drives T₁ and T₂, and u̅_̅{̅R̅}̅(̅t̅)̅ drives T₃ and T₄.

6. The method according to claim 1, wherein power efficiency of driving the floating mass transducer is independent of analog input signal u_{IN}(t).

7. A system for high efficiency vibratory acoustic stimulation, the system comprising:
a modulator having an input for receiving an analog signal u_{IN}(t), and providing at an output, as a function of u_{IN}(t), a binary rectangular signal output u_{R}(t) with two levels V_{CC} and GND;
a switching network coupled to u_{R}(t) so as to switch nodes N₁ and N₂ between V_{CC} and ground; and
a floating mass transducer coupled between nodes N₁ and N₂ to a capacitor C in parallel, and further to a coil L in series.

8. The system according to claim 7, wherein the modulator is a ΔΣ-modulator.

9. The system according to claim 7, wherein the modulator is a pulse width modulator.

10. The system according to claim 7, wherein the switching network connects N₁ to ground when N₂ is connected to V_{CC}, and connects N₁ to V_{CC} when N₂ is connected to ground.

11. The system according to claim 10, wherein N₁ is coupled to V_{cc} via a PMOS-transistor T₁, wherein N₁ is coupled to ground via a NMOS-transistor T₂, wherein N₂ is coupled to Vcc via a PMOS-transistor T₃, wherein N₂ is coupled to ground via a NMOS-transistor T₄, and wherein u_{R}(t) drives T₁ and T₂, and u̅_̅{̅R̅}̅(̅t̅)̅ drives T₃ and T₄.

12. The system according to claim 7, wherein power efficiency of driving the floating mass transducer is independent of analog input signal u_{IN}(t).
